(19) United States
(12) Patent Application Publication
(10) Pub. No.: US 2002/0140688 A1
(43) Pub. Date: Oct. 3, 2002

(54) Low information content display

(76) Inventors: Robert B. Steinberg, Shaker Heights, OH (US); Pradeep S. Iyer, Hacienda Heights, CA (US)

Correspondence Address: Jonathan A. Platt, Renner, Otto, Boisselle & Sklar, LLP, Nineteenth Floor, 1621 Euclid Avenue, Cleveland, OH, 44115-2191, US

(21) Appl. No.: 10/152,223

(22) Filed: May 20, 2002

Related U.S. Application Data
(63) Continuation of application No. PCT/US00/31903, filed on Nov. 20, 2000.
(60) Provisional application No. 60/166,482, filed on Nov. 19, 1999.

(51) Int. Cl. G09G 5/00

(52) U.S. Cl. 345/205

(57) ABSTRACT

A display system includes a low power flexible film display component. The display may include an attention-grabbing mechanism, such as flashing, apparent motion within the display, or animation. The display may involve interactivity between the user and the display, with the display including for example user-operated switches that change portions of the display. The display may be attached to a product, and may be powered by a separate power unit.

This application is a continuation of International Application No. PCT/US00/31903, filed Nov. 20, 2000, published in English as WO 01/37244, which claims the benefit of U.S. Provisional Application No. 60/166,482, filed Nov. 19, 1999. All of the above are hereby incorporated by reference in their entireties.

### FIELD OF THE INVENTION

This invention is in the field of information displays. More particularly, the invention is in the field of attention-getting information displays, such as for use on products, signs, and/or in retail settings.

### BACKGROUND OF THE INVENTION

A merchandising store, such as a grocery supermarket, displays goods for sale on shelves with a label or sign conveying information regarding the type of goods, manufacturer, package quantity, price, and/or per-unit-cost. Some of this information rarely changes, such as the description of the item (type of goods, manufacturer, package quantity) as this information is not affected by fluctuations in market conditions. Other information changes frequently, such as the price and thus the per-unit-cost of an item. Also, as certain goods are placed on “sale”, it is usually desirable to display this sale status along with the other information.

To accommodate frequently fluctuating information, signs may be reprinted and then used to replace previously provided printed signs. However, in a large supermarket setting, for example, this can be a very expensive and time consuming task. Furthermore, if such printing is done off-premise, accuracy and turn-over time become significant factors. Also, in this age of electronic displays, such printed or fixed signs seldom attract much visual attention from customers. That being said, printed signs are economically advantageous, at least from a manufacturing point of view, whereby their replacement with more expensive electronic displays is often not commercially justified.

### SUMMARY OF THE INVENTION

The present invention provides a sign system that displays frequently fluctuating purchase information for different goods in a commercial setting. The system includes a plurality of signs each comprising an electrochromic display which displays the frequently fluctuating purchase information relating to the respective goods and a display-changing device. The changing device provides signals to the electrochromic displays to selectively change the frequently fluctuating purchase information on the electrochromic displays to correspond to the respective goods. For example, the electrochromic displays may display information relating to prices and costs-per-unit. Further, signs may be used in a variety of other settings for providing information, for example on products and menus, at service locations, and for applications such as board games. Also, the electrochromic display may provide information relating to the sale status of certain goods. Alternatively, other types of displays, such as electromechanical displays may be used.

In this manner, frequently fluctuating information may be displayed quickly and accurately without the time and cost of reprinting signs and without the handling and placing of the reprinted signs. Also, the electrochromic display will often attract more visual attention from customers as compared to, for example, a fixed or printed display. Further, the relevant frequently fluctuating information (e.g., price, sale status, etc.) may be communicated clearly to customers thereby eliminating confusion and error.

By using electrochromic or other displays, the signs may be manufactured in an economic manner when compared to, for example, signs incorporating CRT or LCD displays. The display may be solar-powered with a battery back-up whereby it requires no hard wiring into the electrical system of the facility. Alternatively, the display may be fully battery powered, or may be powered via an AC connection, with or without a battery back up.

The display-changing device may include a hand-held device which may be carried by personnel throughout the store to change the electrochromic displays. The new/updated information may be manually input via the hand-held device or this data may be downloaded from a computer to the hand-held device for manual input. In either event, the updated sign may be checked on site for accuracy and, if an error occurs, immediately corrected.

The sign system according to the present invention may be used in a variety of commercial or retail settings, such as grocery stores, mass merchandisers, department stores, big box retailers, discount department stores, specialty retailers, and consumer goods manufacturers.

According an aspect of the invention, a display system includes display units secured to objects, wherein each of the display units includes an information display and a power connection for receiving power; and a power source separate from the display units and operatively configured to interface with the power connection.

According to another aspect of the invention, a display system includes a flexible display material for displaying information; and means for securing the display material to an object.

According to yet another aspect of the invention, a sign system for providing purchase information for different goods in a commercial setting, said system includes a plurality of signs each comprising an electrochromic display which displays frequently fluctuating purchase information relating to the respective goods; and a display-changing device which provides signals to the electrochromic displays to selectively change the frequently fluctuating purchase information on the electrochromic displays to correspond to the respective goods.

According to still another aspect of the invention, a method of using a sign system includes the steps of providing one of a plurality of signs for each of the different goods in the commercial setting; and a using a display-changing device to provide the signals to electrochromic displays to selectively change the frequently fluctuating purchase information on the electrochromic displays to correspond to the respective goods.

According to a further aspect of the invention, a sign system for providing purchase information for different goods in a commercial setting includes a plurality of signs each comprising a changeable display which displays frequently fluctuating purchase information relating to the respective goods; and a display-changing device which provides signals to the changeable displays to selectively change the frequently fluctuating purchase information on the displays to correspond to the respective goods.

According to a still further aspect of the invention, a display includes a first portion and a second portion with a boundary therebetween, wherein the portions are operatively configured for selective change of the color of the first portion relative to the color of the second portion, and wherein the portions are operatively configured such that the selective change causes a region of the first portion near the boundary to selectively change color before or after another region of the first portion.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

In the annexed drawings:

FIG. 1 is a schematic view of a sign system according to the present invention;

FIG. 2 is a perspective view of one of the plurality of signs of the sign system;

FIG. 3 is cross-sectional schematic view of one embodiment of an electrochromic structure for a display in accordance with the present invention;

FIG. 4 is a schematic view illustrating a visual effect achievable in accordance with the present invention;

FIG. 5 is a schematic view of an interactive display system in accordance with the present invention; and

FIG. 6 is a schematic view of an alternate embodiment display system in accordance with the present invention.

### DETAILED DESCRIPTION

A display system includes a low power flexible film display component. The display may include an attention-grabbing mechanism, such as flashing, apparent motion within the display, or animation. The display may involve interactivity between the user and the display, with the display including for example user-operated switches that change portions of the display.

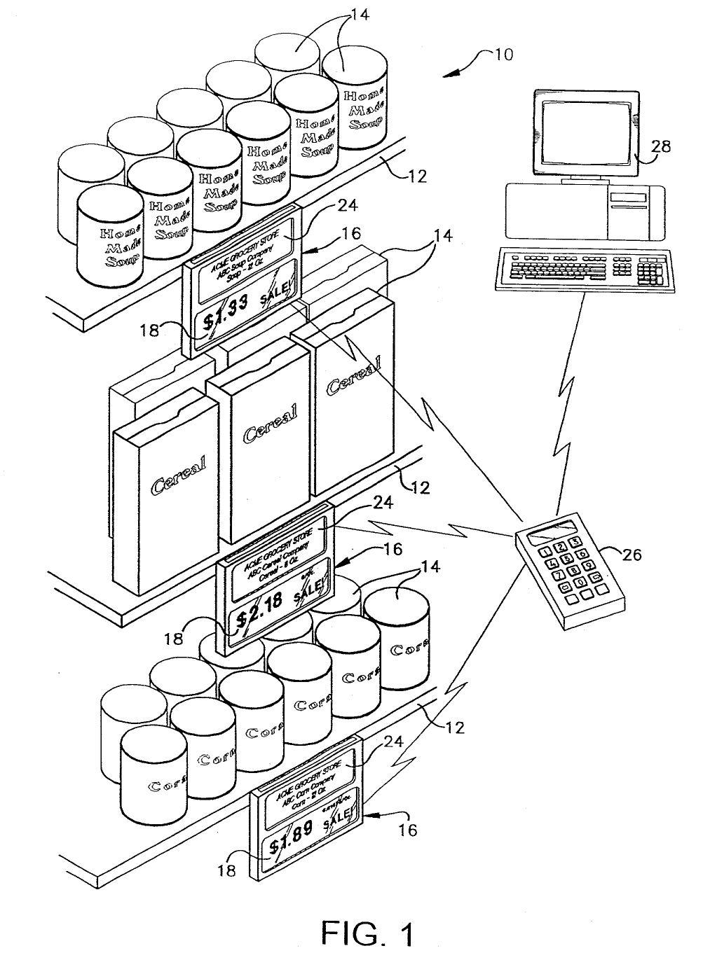

One example of the present invention, a sign system 10, is schematically illustrated in FIG. 1. In the illustrated embodiment, the sign system 10 is used in a grocery store setting including a plurality of shelves 12 on which different goods 14 are placed for purchase by a consumer. The system 10 includes a plurality of signs 16 which are located relative to the shelves 12 to convey information regarding the respective goods 14.

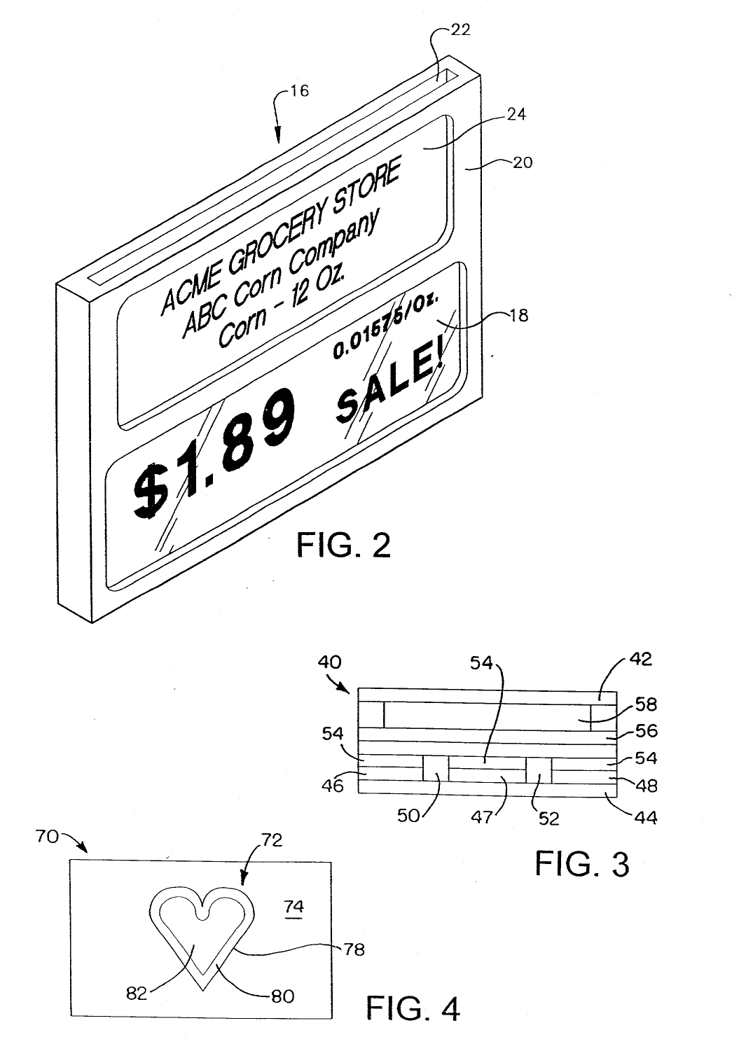

Referring now additionally to FIG. 2, each sign 16 includes an electrochromic display 18. The electrochromic display 18 utilizes an electrolyte layer in contact with an electrochromic material. By applying an electrical potential across an interface between the electrolyte and the electrochromic material, an electrochromic effect can be generated which changes the color or optical density of the electrochromic material. Examples of suitable electrochromic displays are disclosed in U.S. Pat. Nos. 5,891,511, 5,877,888, 5,876,634, 5,876,633, 5,852,509, 5,812,300, 5,760,945, 5,754,329, 5,742,424 and 5,413,739, the entire disclosures of which are hereby incorporated by reference.

The electrochromic display 18 displays frequently fluctuating information regarding the respective goods 14 such as, for example, price and per-unit-cost of an item. Also, as certain goods are placed on “sale”, the electrochromic display 18 may display this sale status. The display 18 is preferably powered by a solar cell, with a battery back-up whereby it requires no hard-wiring into the facility's electrical system. An electrostatic discharge protector may be incorporated into the display.

The changeable display 18 has been described as an electrochromic display. It should be noted, however, that other types of selectively changeable displays are possible with, and contemplated by, the present invention. For example, an electromechanical display, an electrophoretic display, an electrofluorescent, an electroluminescent display, a liquid crystal display, and/or a cathode ray tube display may be used. These and other displays which are electrically changeable by an electrical field and/or an electrical beam are possible with, and contemplated by, the present invention. Also, thermally or otherwise activated displays are possible with and contemplated by the present invention.

The illustrated sign 16 includes a housing 20 on which the electrochromic display 18 is mounted. The housing 20 may include a windowed slot 22 for receipt of a printed label 24 displaying rarely changing information such as, for example, the identity of the grocery store, a description of the goods, the manufacturer of the goods, and/or a package quantity.

Other housing arrangements and/or housingless arrangements may be used in conjunction with the sign 16. Also, in the illustrated embodiment, the sign 16 is positioned perpendicular to the top surface of the shelf 12 and extends downward from its outer edge. Other positions and/or mountings of the sign 16 are possible with, and contemplated by the present invention. For example, the sign 16 could be positioned perpendicular to the outer edge of the shelf or it could be positioned parallel with the top surface of the shelf 12. Additionally or alternatively, for example, the sign 16 could be mounted to the top surface of the shelf 12, supported on a suitable easel, or suspended from a wall or ceiling.

Referring now back to FIG. 1, the sign system 10 further includes a display-changing device 26 which provides signals to the electrochromic displays 20 to selectively change the frequently fluctuating information to correspond to the respective goods. The display-changing device 26 may be a hand-held unit that can be carried by personnel throughout the store to change the electrochromic displays 18. The new/updated information may be manually input via the hand-held device 26 or this data may be downloaded from a computer 28 to the hand-held device for manual input. In either event, the updated sign may be checked on site for accuracy and, if an error occurs, immediately corrected. That being said, the display-changing device 26 need not be a hand-held unit. The device 26 may instead be, for example, a unified infrared device capable of changing the display on more than one device at a time, or the displays may be addressed directly by hard-wired circuitry.

Examples of hand-held devices include wireless devices which transmit information via an infrared, radio frequency, or other signal; pagers, cellular, or other wireless phones; and personal digital assistants. It will be appreciated that the sign system 10 may have connections for receiving updating information from other devices. For example the system 10 may have a connection(s) for interfacing with a personal computer and/or for interfacing with an Internet connection.

The hand-held device 26 make include means for downloading information from a computer or network, for example including a serial port. The system 10 may include software for use on the computer or network to organize data, for example to create a price and sign database, and to download the data to the hand-held device 26.

Thus, the present invention provides a sign system 10 that displays frequently fluctuating purchase information for different goods in a commercial setting. In this manner, frequently fluctuating information may be displayed quickly and accurately without the time and cost of reprinting signs and without the handling and placing of the reprinted signs. Also, the electrochromic display 30 will often attract more visual attention from customers as compared to, for example, a fixed or printed display. Further, the relevant frequently fluctuating information (e.g., price, sale status, etc.) may be communicated clearly to customers thereby eliminating confusion and error.

If the changeable displays are electrochromic displays 18, the signs 16 may be manufactured in an economic manner (when compared to, for example, signs incorporating CRT or LCD displays). The sign system 10 may be used in a variety of commercial or retail settings, such as grocery stores, mass merchandisers, department stores, big box retailers, discount department stores, specialty retailers, and consumer goods manufacturers.

Turning now to FIG. 3, an electrochromic structure 40, suitable for use with the electrochromic display 18, is schematically illustrated. The structure 40 has a top substrate 42 and a bottom substrate 44. The substrates 42 and 44 may be 5 mil thick sheets of flexible PET film. Alternatively, the substrates 42 and/or 44 may include a wide variety of suitable light-transmissive materials, such as plastics and glass.

The substrate 42 has side-by-side electrodes 46-48 thereupon. Adjacent pairs of the electrodes 46-48 are separated by dielectric elements 50 and 52. The electrodes 46-48 are connected to a voltage source for selectively providing power to the electrodes to control the transmission of light through the electrochromic structure 40. The electrochromic structure also includes an ion storage elements 54, an electrochromic layer 56, and an electrolyte layer 58.

Suitable electrode, electrolyte, ion storage, and electrochromic materials, and configurations and methods for their use, are described, for example, in U.S. Pat. Nos. 5,413,739, 5,500,759, 5,742,424, 5,812,300, 5,754,329, 5,760,945, 5,877,888, 5,876,633, 5,876,634, 5,891,511, and 6,084,701, all of which are incorporated herein in their entireties.

It will be appreciated that other layers may be coupled to the electrochromic structure 40 described above. For example, one or more color filter films may be used to provide color to parts or all of the display. As another example, layers with printed or otherwise applied indicia may be provided to show words, pictures, and/or symbols on the display.

The display may be a flashing display, with reversal of polarity of the power supply for the electrochromic display controlled by a suitable switching circuit. The display may include a flashing nameplate, or some form of flashing graphic image. The flashing graphic may be a stand-alone decorative graphic or may be combined with conventionally-printed graphics (either directly printed or reverse printed) to enhance the attention-getting ability of the display. Examples of such graphic images include hearts that beat, stars that sparkle, and pain that throbs. The flashing effect may also be accomplished by use of a vinyl film that is cut to provide a shape or a stencil (a positive or negative of the image), and is then adhered to or placed in front of the display. The change of the display from one color to the matched color appears to make the vinyl shapes or letters appear or disappear.

FIG. 4 is an illustration of an example of a progressive saturation visual effect which may be included as part of a display 70. The display 70 includes a first section 72 surrounded by a second section 74, with a boundary 78 therebetween. The boundary 78 is a closed boundary, with the second section 74 surrounding the first section 72. The first and second sections are operatively configured to selectively visually display a feature, for example by selective change of the color of the first portion 72 relative to the color of the second portion 74. For example, the portions may be operatively configured such that the first portion 72 is a first color when the second portion is a second color 74, and vice versa. The term “color,” as used herein, includes differences in shade, with the portions for example toggle between light gray and dark gray.

When the relative color difference between the first section 72 and the second section 74 is changed, the change does not occur uniformly. Rather, for example, change begins at the boundary 78, with color saturation of peripheral region 80 near the boundary occurring first, followed by color saturation in a central region 82 which is away from the boundary 78. A reversal of the process may involve the central region 82 first becoming a different color, followed by the peripheral region 80 near the boundary 78.

It will be appreciated the “beating heart” progressive saturation visual effect illustrated in FIG. 4 and described above is only one small example of the visual effects which are possible. Objects may be made to pulsate and/or throb, hearts may be made to beat, and a wide variety of complex shapes may be employed to give the appearance of movement.

The effects described above may be achieved by use of thermochromic displays. Alternatively, suitable electrochromic displays may be utilized to achieve such a “filling in” effect. For example, an electrochromic display may have a working electrode corresponding to the first section 72 and a counter electrode corresponding to the second section 74, and reversal of the polarity of the electrodes may be used to produce the filling effect.

It will be appreciated it may be possible that the first section 72 and the second section 74 may be configured such that one does not surround the other, but that there is an open boundary between the first section and the first section.

Motion may be simulated in the display by changing color of previously printed images. Examples include eyes that move, hands that wave, falling snow flakes, rising balloons, and dripping water.

Alternatively or in addition, a wide variety of animated and/or instructional graphics may be displayed. For example, the display may be mounted on an appliance. The display may be operatively coupled to sensors on the appliance, and may utilize graphic displays such as a stacked bar chart or a pie chart to indicate changed conditions when coupled, such as changes in temperature or humidity, or movement of components or objects. As another example, single or multi-panel cartoons may be used to illustrate or demonstrate a process, such as a process of preparing foods or assembling component parts of a machine.

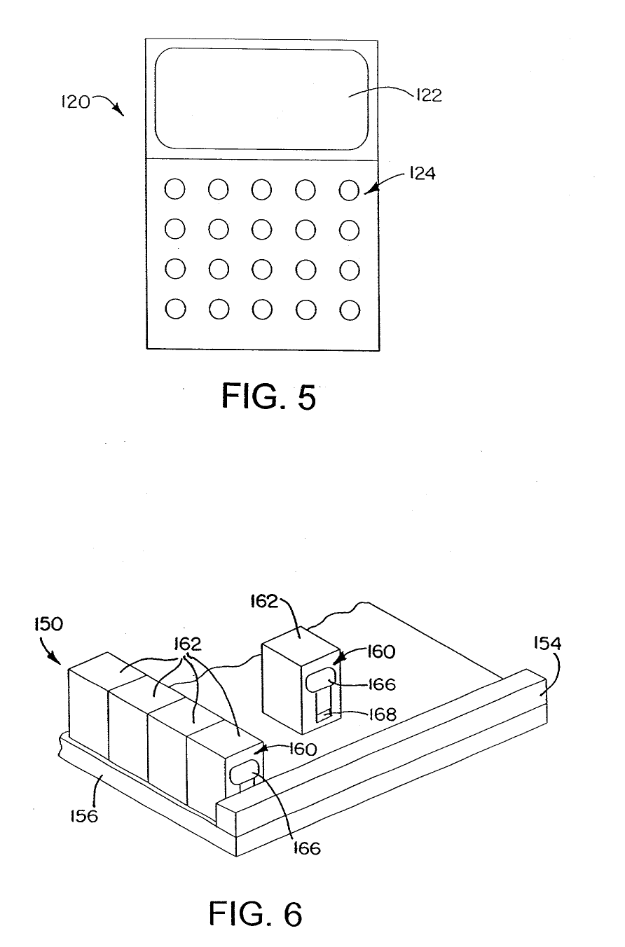

Turning now to FIG. 5, an interactive display system 120 is shown. The display system 120 includes a display 122 and switches 124. The display 122 may be an electrochromic or other type of display, such as described above. The switches 124 allow for user interaction with the display 122. For example, pressing one or more of the switches 124 may cause a portion 126 of the display to energize or flash. There may be a respective portion of the display corresponding to each of the switches 124. For example, the display 122 may be of an area map, with each of the switches 124 corresponding to a destination, with the lit or flashing portion 126 corresponding to a travel route for the destination. The route may be displayed by a series of flashing lines or flashing footprints. As another example, the display 122 may be of a wiring diagram or circuit layout, with the switches 124 corresponding to individual circuits, paths, or components which are energized or flashed in order to assist in troubleshooting or repairing a device.

FIG. 6 shows another embodiment of the present invention, a display system 150 which has separate displays and power supplies. The display system 150 includes a power supply and driving circuitry unit 154 which is mounted on a shelf 156. Display units 160 are attached to products 162, to provide a means to draw attention to the products. The display units 160 each include a display 166, as well as a power/driving interface 168 for operatively coupling to the power/circuitry unit 154. The power/driving unit 154 provides power and driving information to the display unit 160 which is contact with it, in the illustrated case the display unit of the front product 162. The display units 160 on the products which are behind the front unit are not in contact with the power/circuitry unit 154, and therefore consume no power and display nothing. A mechanism may be used to maintain the front display unit 162 in contact with the power/driving unit 154. For example, the shelf 156 may be sloped. As another example, the shelf 156 may include a spring mechanism which urges the products 162 forward.

The display system 150 has several advantageous features. First, it allows relatively-inexpensive display units to be attached to and sold along with products, while allowing re-use of the relatively expensive power and driving circuitry. Second, the display system reduces energy consumption and cost by providing power to only the forward-most display unit, the one seen by consumers. This also enhances display life.

It will be appreciated that the display units 160, or the other displays described herein, may be attached to products or other objects by a variety of means. For example, the display units may be attached using suitable adhesives. Alternatively, the display units may be attached using fasteners such as rivets, screws, bolts, nails, etc. As another alternative, the display units may be attached using a hook and loop material such as the material sold under the trademark VELCRO. Alternatively, the display units may be secured by another sort of mechanical connection, for example by sliding into a suitably-dimensioned slot. It will be appreciated that many other suitable methods of attachment and/or securement are well known in the art.

It will further be appreciated that displays such as the display 160 may be used for product authentication. The display 160 may be an inexpensive display configured to show indicia of product authenticity when power is supplied to the display. Though inexpensive, such a display may be difficult for product counterfeiters to manufacture, and thus may be used for assuring authenticity of products to which it is attached.

It will be appreciated that a display decoupled from a power source may be used as a component of a dosimeter for measuring exposure to light or other types of radiation. For example, a photovoltaic cell may be coupled to a display to provide an amount of power to the display which is dependent on the amount of light or other radiation incident on the photovoltaic cell. The display may be configured to provide an indication of the amount of light or other radiation incident on the photovoltaic cell. Alternatively or in addition the display may be configured to provide an indication of the cumulative amount of light or other radiation incident on the photovoltaic cell.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A display system comprising:
display units secured to objects, wherein each of the display units includes an information display and a power connection for receiving power; and
a power source separate from the display units and operatively configured to interface with the power connection.

2. The system of claim 1, further comprising means for holding one or more of the objects in contact with the power source.

3. The system of claim 1, wherein the display units are adhesively attached to respective of the objects.

4. The system of claim 1, wherein the information displays include flexible display material.

5. The display system of claim 4, wherein the flexible display material includes a pair of flexible substrate layers.

6. The display system of claim 5, wherein the flexible substrate layers are PET layers.

7. The display system of claim 4, wherein the flexible display material includes a layer of electrochromic material.

8. The display system of claim 4, wherein the flexible display material further includes an electrolyte layer.

9. The display system of claim 4, wherein the flexible display material includes a color film.

10. The display system of claim 1, wherein the display includes means for flashing the displayed information.

11. A display system comprising:
a flexible display material for displaying information; and
means for securing the display material to an object.

12. The display system of claim 11, wherein the flexible display material includes a pair of flexible substrate layers.

13. The display system of claim 11, wherein the flexible display material includes a layer of electrochromic material.

14. The display system of claim 12, wherein the flexible display material further includes an electrolyte layer.

15. The display system of claim 11, wherein the display includes means for flashing the displayed information.

16. The display system of claim 11, wherein the display includes means for displaying apparent movement of displayed images.

17. The display system of claim 11, further comprising user-accessible switches operatively coupled to the display material, wherein the switches are operatively configured in concert with the display material to allow the displayed information to be affected by activation of the switches.

18. The display system of claim 11, further comprising a display-changing device which provides signals to the display to selectively change the displayed information on the display.

19. The display system of claim 18, wherein the display-changing device is a wireless hand-held device.

20. The display system of claim 19, wherein the wireless device is operatively configured to send infrared signals, and the display is operatively coupled to a means for receiving the infrared signals.

21. The display system of claim 11, wherein the display is operatively coupled to a connection for receiving power from an external power source.

22. The display system of claim 21, wherein the connection also includes means for receiving control signals.

23. A sign system for providing purchase information for different goods in a commercial setting, said system comprising:
a plurality of signs each comprising an electrochromic display which displays frequently fluctuating purchase information relating to the respective goods; and
a display-changing device which provides signals to the electrochromic displays to selectively change the frequently fluctuating purchase information on the electrochromic displays to correspond to the respective goods.

24. A sign system as set forth in claim 23, wherein the electrochromic display displays information relating to the prices of the respective goods.

25. A sign system as set forth in claim 23, wherein the electrochromic display displays information relating to the sale status of the respective goods.

26. A sign system as set forth in claim 23, wherein each sign additionally comprises a static display which displays rarely-changing information relating to the respective goods.

27. A sign system as set forth in claim 23, wherein each sign additionally comprises a housing on which the electrochromic display is supported.

28. A sign system as set forth in claim 27, wherein the housing of each sign includes a windowed slot and wherein a static display is received within this windowed slot, the static display displaying rarely-changing information relating to the respective goods.

29. A sign system as set forth in claim 27, wherein the static display contains information relating to an identify of the commercial setting.

30. A sign system as set forth in claim 27, wherein the static display contains information relating to a description of the respective goods.

31. A sign system as set forth in claim 23, wherein the electrochromic displays are solar powered.

32. A sign system as set forth in claim 23, wherein the electrochromic displays include a battery back-up.

33. A sign system as set forth in claim 23, wherein the display-changing device is a hand-held device that may be carried throughout the commercial setting to change the electrochromic displays.

34. A sign system as set forth in claim 33, wherein the new/updated information is manually input via the hand-held device.

35. A sign system as set forth in claim 34, wherein data is downloaded from a computer to the hand-held device for manual input.

36. A method of using a sign system to provide purchase information for different goods in a commercial setting, the method comprising:
providing one of the plurality of signs of the system for each of the different goods in the commercial setting, wherein the signs each include an electrochromic display which displays frequently fluctuating purchase information relating to the respective goods; and
using a display-changing device of the system to provide signals to the electrochromic displays to selectively change the frequently fluctuating purchase information on the electrochromic displays to correspond to the respective goods.

37. A method as set forth in claim 36, wherein the using step comprises providing information relating to prices of the respective goods.

38. A method as set forth in claim 36, wherein the using step comprises providing information relating to the sale status of the respective goods.

39. A method as set forth in claim 36, further comprising providing a static display which displays the rarely-changing information relating to the respective goods.

40. A method as set forth in claim 36, further comprising the step of providing a static display by placing the static display in the windowed slot.

41. A method as set forth in claim 40, wherein the providing the static display includes providing the static display with information relating to the identity of the commercial setting.

42. A method as set forth in claim 41, wherein the providing the static display comprises providing the static display with information relating to a description of the respective goods.

43. A method as set forth in claim 36, wherein the display-changing device is a hand-held device, and further comprising carrying the hand-held device throughout the commercial setting to change the electrochromic displays.

44. A method as set forth in claim 43, further comprising manually inputting the new/updated information via the hand-held device.

45. A method as set forth in claim 43, further comprising downloading data from a computer to the hand-held device for manual input.

46. A method as set forth in claim 43, further comprising the step of checking the updated sign for accuracy.

47. In combination, the sign system of claim 23 and a commercial setting, the plurality of signs being placed within the commercial setting adjacent the respective goods.

48. A combination as set forth in the claim 47, wherein the commercial setting is a grocery store, a mass merchandiser, a department store, a big box retailer, a discount department store, a specialty retailer, and/or a consumer goods manufacturer.

49. A sign system for providing purchase information for different goods in a commercial setting; said system comprising:
a plurality of signs each comprising a changeable display which displays frequently fluctuating purchase information relating to the respective goods; and
a display-changing device which provides signals to the changeable displays to selectively change the frequently fluctuating purchase information on the displays to correspond to the respective goods.

50. A sign system as set forth in claim 49, wherein the changeable display is an electrically changeable display

51. A sign system as set forth in claim 50, wherein the electrically changeable display is an electrophoretic display, an electrofluorescent display, an electromechanical display, an electroluminescent display, a liquid crystal display, and/or a cathode ray tube display.

52. A sign system as set forth in claim 49, wherein the changeable display is a thermally changeable display.

53. A display comprising a first portion and a second portion with a boundary therebetween, wherein the portions are operatively configured for selective change of the color of the first portion relative to the color of the second portion, and wherein the portions are operatively configured such that the selective change causes a region of the first portion near the boundary to selectively change color before or after another region of the first portion.

54. The display of claim 53, wherein the selective change is accomplished by a thermochromic process.

55. The display of claim 53, wherein the selective change is accomplished by an electrochromic process.

56. The display of claim 53, wherein one of the portions surrounds the other of the portions.
